(19) United States
(12) Patent Application Publication
(10) Pub. No.: US 2016/0231800 A1
(43) Pub. Date: Aug. 11, 2016

(54) PROTechHN - Battery Monitor

(71) Applicant: Fernando Miguel Flores, Tegucigalpa (HN)

(72) Inventor: Fernando Miguel Flores, Tegucigalpa (HN)

(21) Appl. No.: 14/617,311

(22) Filed: Feb. 9, 2015

(51) Int. Cl. G06F 1/32; G06F 1/26

(52) U.S. Cl. CPC G06F 1/3212; G06F 1/3287; G06F 1/263

(57) ABSTRACT

What this invention does is allow/deny the flow of electricity to a Windows based laptop's AC Adapter from the power outlet, when the laptop's battery reaches the minimum or maximum battery level percentage that is set by the user, in the application that has to be installed in a Windows based laptop. The user is able to change these values at any time or reset the values to their defaults.

### CROSS-REFERENCE TO RELATED APPLICATIONS

### BACKGROUND OF THE INVENTION

One of the common errors that occur in Windows based Laptops is battery failure, due to overcharge.

Currently, there is an invention that protects computers from powering off, when the power goes out, called UPS (Uninterruptible power supply), but it does not protect the laptop's battery from malfunctioning due to overcharge.

PROTechHN-Battery Monitor, prevents the laptop's battery from malfunctioning, due to overcharge, extends the laptop's battery life span, and saves energy consumption.

### BRIEF SUMMARY OF THE INVENTION

The invention consists of a hardware and a software. The software runs on Windows based laptops, and it monitors for battery percentages set by the User. When the laptop's battery reaches these percentages, the software sends a signal to the hardware, so that it allows/denies the flow of electricity from the power outlet to the laptop. These percentages can be changed at anytime by the user.

### BRIEF DESCRIPTION OF DRAWINGS

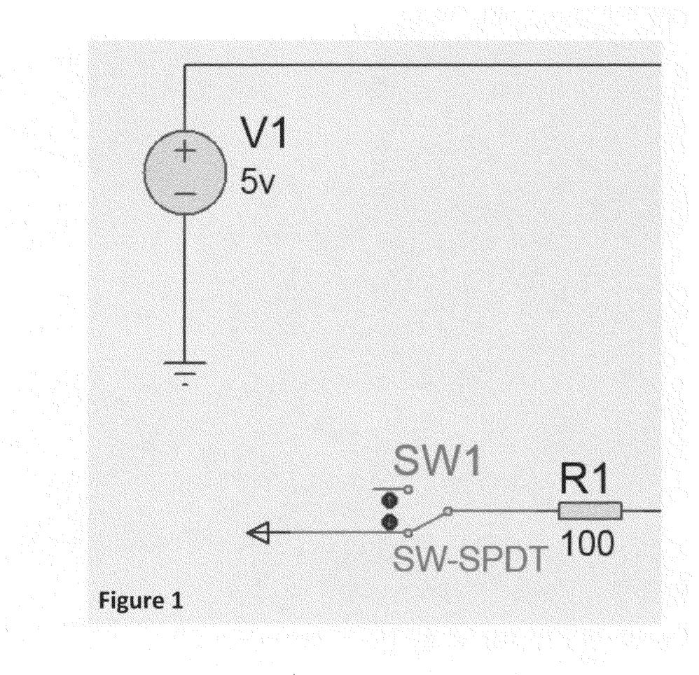

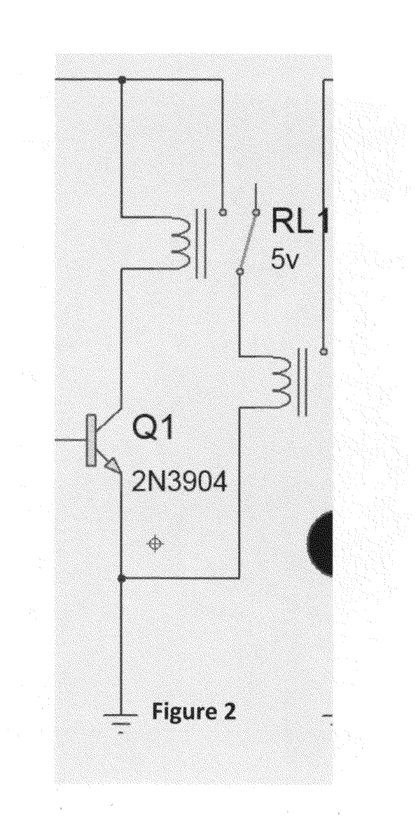

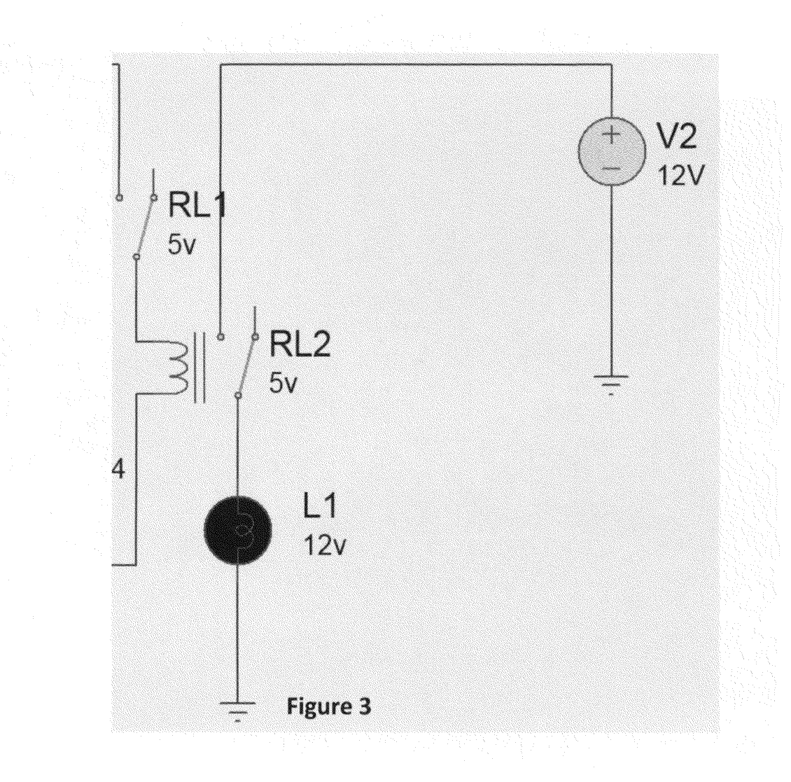

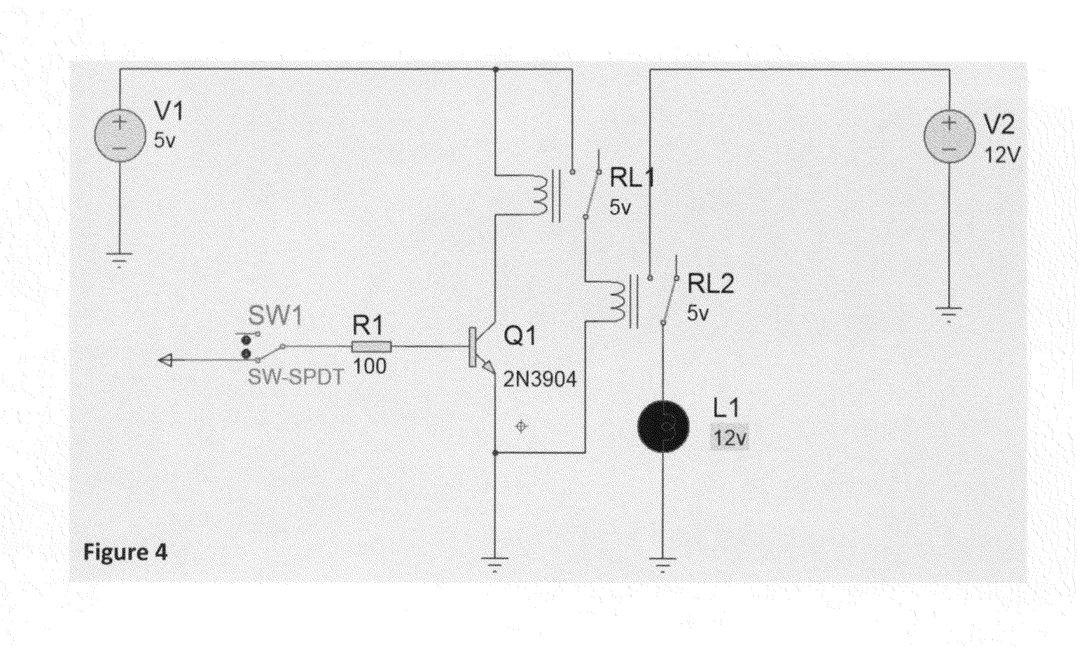

The drawings show how the electric components are placed on the circuit board, to make the hardware work as it is intended. It is divided in three parts, labeled FIG. 1, FIG. 2, FIG. 3, and FIG. 4:

1. FIG. 1 shows where the PIC Microcontroller goes connected. The 5V, that the PIC Microcontroller gives off directly from the USB port, goes connected to the Relay, in part B (RL1). The switch (SW1) represents the 5V that the pin of the PIC Microcontroller gives off, when either the maximum or the minimum battery level percentage is reached.

2. FIG. 2 shows when the minimum percentage is reached, the PIC Microcontroller in part A, sends 5V to the relay in part B, making it turn on the relay (RL2) in part C, that in turn turns on the light bulb (L1), that represents the Computer's AC Adapter. When the maximum percentage is reached, the PIC Microcontroller stops sending the 5V signal, and the circuit denies the flow of electricity.

3. FIG. 3 shows the computer's AC Adapter (L1) is connected to one end of an extension that passes through the circuit, and the other end is connected to the power outlet. The electricity that flows through the extension is interrupted by the relay (RL2) shown in part C. When the relay (RL1) in part B is activated, then the relay (RL2) in part C is also activated and the energy flows into the computer's AC Adapter and starts charging the computer's battery.

4. FIG. 4 shows when the PIC Microcontroller, represented by the switch (SW1) in Figure A, sends the 5V signal to turn on the relay (RL1) in part B, this relay lets the 5V coming directly from the USB port, go into the relay (RL2) in part C, passing through the PIC Microcontroller. This makes the relay (RL2) in part C turn on and it lets the voltage flow into the laptop's AC Adapter, making it turn on.

### DETAILED DESCRIPTION OF THE INVENTION

This invention consists of a hardware and a software. The software is an application that was designed to work on Windows based computers. This software was compiled in C# (C-Sharp). It automatically detects when the PIC Microcontroller is connected or changed to a different USB port in the computer, through a USB Cable. It has 2 Text Fields, that represent the minimum and maximum battery percentages, so that the user can change them at anytime. These are the battery level percentages that the software is looking for, so that when they are reached, it can send a signal to the PIC Microcontroller, so that it can allow/deny the flow of electricity to the laptop, through the circuit.

The hardware consists of:
1. PIC Microcontroller (PIC18f2550, SW1 in circuit diagram)
2. 1 Resistor (from 100 Ω-230 Ω, R1 in circuit diagram)
3. 1 Relay (10V DC, 500mA, activated by a 5V signal, RL1 in circuit diagram)
4. 1 NPN Transistor (2n3904 or 2n2222, Q1 in circuit diagram)
5. 1 Relay (240V AC, 10A, Activated by a 5V signal, RL2 in circuit diagram)
6. 1 meter Extension cord, with a three pin connection.

1. A device that allows/denies the flow of electricity to the computer's AC Adapter from the power outlet.

2. The invention in claim 1, further uses a software that sends the signal to the device, so that it can allows/denies the flow of electricity to the computer's AC Adapter from the power outlet.

3. The invention in claim 1, further protects the windows based laptop's battery from malfunctioning due to overcharge, and it also reduces energy consumption, saving energy.

4. The software auto-detects the hardware connection to the laptop and the change of USB port.

5. The previous charging state of the laptop remains the same, whether the computer is turned off, restarted, put to sleep or hibernate, until the battery level reaches the minimum/maximum level.

6. The Circuit of the invention in claim 1, can further be used with any USB enabled Microcontroller.

7. The Circuit of the invention in claim 1, can further be used with any Bluetooth enabled Microcontroller.

8. The Circuit of the invention in claim 1, can further be used with any Wifi enabled Microcontroller.

9. The Circuit of the invention in claim 1, can further be used with cellular phones running on android operating systems.

10. The Circuit of the invention in claim 1, can further be used with linux based laptop's.
